(19) United States
(12) Patent Application Publication
(10) Pub. No.: US 2024/0037384 A1
(43) Pub. Date: Feb. 1, 2024

(54) DRIFT-AWARE CONTINUOUS LEARNING

(71) Applicant: Raytheon Company, Waltham, MA (US)

(72) Inventors: Kin Gwn Lore, Belmont, MA (US); Philip A. Sallee, South Riding, VA (US); Franklin R. Tanner, Leesburg, VA (US)

(73) Assignee: Raytheon Company, Waltham, MA (US)

(21) Appl. No.: 17/874,801

(22) Filed: Jul. 27, 2022

(51) Int. Cl. G06N 3/08; G06K 9/62

(52) U.S. Cl. CPC G06N 3/08; G06K 9/6215; G06K 9/6227; G06K 9/6262

(57) ABSTRACT

Systems and methods are provided for updating data in a computer network. An exemplary method includes: receiving input data from at least one device; performing an extraction operation on the input data to extract at least one feature; producing at least one feature vector based on the at least one feature; performing a similarity analysis between the at least one feature vector and a plurality of other feature vectors from a plurality of autoencoders; selecting a first autoencoder from the plurality of autoencoders demonstrating significant similarity with at least one feature vector; determining whether the input data exhibits a recurring drift or a new drift; and training a new autoencoder using at least a portion of the input data.

### BACKGROUND

Machine learning (ML) is a process used to analyze data in which the dataset is used to determine a model that maps input data to output data. For example, neural networks are machine learning models that employ one or more layers of nonlinear units to predict output for a received input. Some neural networks include one or more hidden layers to an output layer. The output of each hidden layer is used as input to the next layer in the network, i.e., the next hidden layer or the output layer. Each layer of the network generates an output from a received input following current values of a respective set of parameters.

In offline learning, one can inspect historical training data to identify contextual clusters through feature clustering or hand-crafting additional features to describe a context. While offline training enjoys learning reliable models based on already-defined contextual features, online training (i.e., training in real-time) for streaming data may be more challenging. For example, the underlying context during a machine learning process may change, resulting in an under-performing model being learned due to contradictory evidence observed in data within high-confusion regimes. The problem is exacerbated when data observed by the model starts to drift producing unreliable results.

There have been several approaches, using ML, to detect whether drift has occurred in an underlying model data. However, these approaches do not have an additional understanding on whether the drift is new or recurring (similar to past observations). Many of these prior approaches simply train a model with the newest data and paired learners, then compare error rates between them.

### SUMMARY

According to one aspect of the subject matter described in this disclosure, a system for training a machine learning model is provided. The system includes one or more computing device processors, and one or more computing device memories. The one or more computing device memories are coupled to the one or more computing device processors. The one or more computing device memories storing instructions executed by the one or more computing device processors. The instructions are configured to: receive input data from at least one device; perform an extraction operation on the input data to extract at least one feature; produce at least one feature vector based on the at least one feature; perform, using a similarity metric, a similarity analysis between the at least one feature vector and a plurality of other feature vectors from a plurality of autoencoders; select, based on the similarity analysis, a first autoencoder from the plurality of autoencoders demonstrating substantial similarity with at least one feature vector, determine, using current data of the first autoencoder, whether the input data exhibits a recurring drift or a new drift; and upon determining the input data exhibits the new drift, train a new autoencoder using at least a portion of the input data.

According to another aspect of the subject matter described in this disclosure, a method for training a machine learning model is provided. The method includes the following: receiving input data from at least one device; performing an extraction operation on the input data to extract at least one feature; producing at least one feature vector based on the at least one feature; performing, using a similarity metric, a similarity analysis between the at least one feature vector and a plurality of other feature vectors from a plurality of autoencoders; selecting, based on the similarity analysis, a first autoencoder from the plurality of autoencoders demonstrating substantial similarity with at least one feature vector; determining, using current data of the first autoencoder, whether the input data exhibits a recurring drift or a new drift; and upon determining the input data exhibits the new drift, training a new autoencoder using at least a portion of the input data.

According to one implementation of the subject matter described in this disclosure, a non-transitory computer-readable storage medium storing instructions which when executed by a computer cause the computer to perform a method for training a machine leaning model is provided. The method includes the following: receiving input data from at least one device; performing an extraction operation on the input data to extract at least one feature; producing at least one feature vector based on the at least one feature; performing, using a similarity metric, a similarity analysis between the at least one feature vector and a plurality of other feature vectors from a plurality of autoencoders; selecting, based on the similarity analysis, a first autoencoder from the plurality of autoencoders demonstrating substantial similarity with at least one feature vector; determining, using current data of the first autoencoder, whether the input data exhibits a recurring drift or a new drift; and upon determining the input data exhibits the new drift, training a new autoencoder using at least a portion of the input data.

Additional features and advantages of the present disclosure is described in, and will be apparent from, the detailed description of this disclosure.

### BRIEF DESCRIPTION OF THE DRAWINGS

The disclosure is illustrated by way of example, and not by way of limitation, in the figures of the accompanying drawings in which like reference numerals are used to refer to similar elements. It is emphasized that various features may not be drawn to scale and the dimensions of various features may be arbitrarily increased or reduced for clarity of discussion.

FIG. 1 is a schematic diagram of an exemplary machine learning system in which one or more aspects of the present disclosure may be implemented, in accordance with some embodiments.

FIG. 2 is schematic diagram of a machine learning model, in accordance with some embodiments.

FIG. 3 is a schematic diagram illustrating the process for determining a recurring or new drift by an autoencoder, in accordance with some embodiments.

FIG. 4 is a process flowgraph of operations included in an example process for a method for training a machine learning model, in accordance with some embodiments.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical similar devices, systems, and methods. Those of ordinary skill may recognize that other elements and/or operations may be desirable and/or necessary to implement the devices, systems, and methods described herein. But because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

The terminology used herein is for the purpose of describing particular example embodiments only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. That is, terms such as “first,” “second,” and other numerical terms, when used herein, do not imply a sequence or order unless clearly indicated by the context.

This disclosure describes a system and method to detect and understand drift in a continuous deployment environment. Appropriate models are created, retrained, and updated in a continuous learning framework. In some embodiments, drift detection is achieved via autoencoders, e.g., convolutional autoencoders. In some other embodiments, other types of autoencoders may be leveraged for drift detection, e.g., based on the type of input data. Drift understanding/characterization is achieved via a bank of autoencoders handling the drift. For example, an autoencoder may be trained to encode data from a low light environment, foggy environment, or the like.). Drift handling and/or retraining are achieved by keeping track of multiple candidate models in the background. The model with a hypothesized drift context is continuously updated with streaming observations (reactive model). The model may be redeployed at the user's decision or automatically deployed after revalidation.

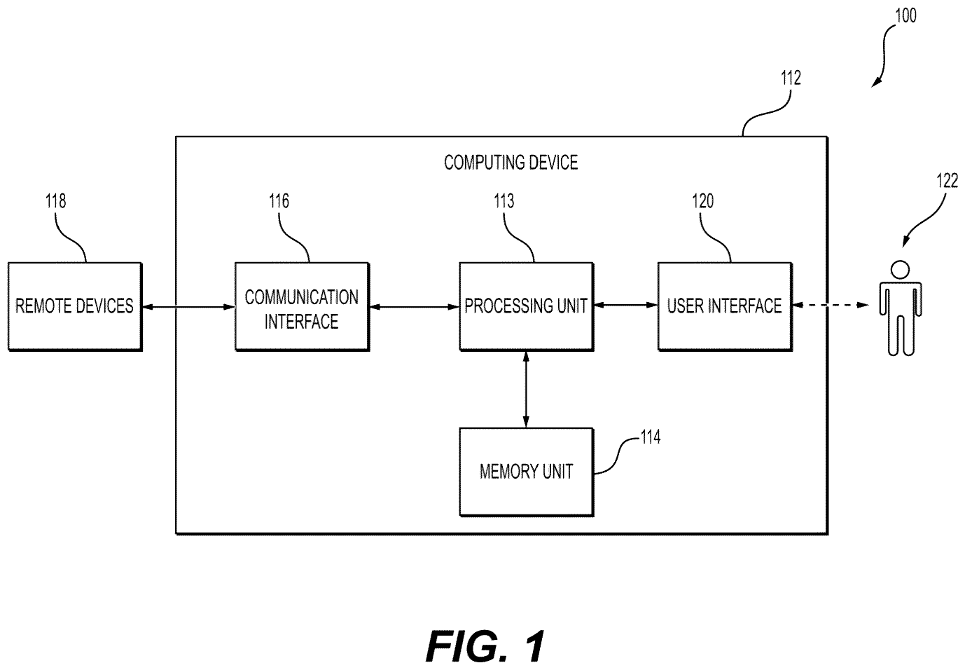

FIG. 1 is a schematic diagram of an exemplary machine learning system 100 in which one or more aspects of the present disclosure may be implemented, in accordance with some embodiments. The machine learning system includes a computing device 112 having a processing unit 113 operatively coupled to a memory unit 114. The processing unit 113 is one or more devices configured to execute instructions for software and/or firmware. For example, the processing unit 113 may include one or more computer processors and/or one or more distributed computer processors.

The memory unit 114 is one or more devices configured to store computer-readable information (e.g., computer programs, data, etc.). A communication interface 116 communicates with one or more devices 118. The one or more devices 18 may include remote devices as well as on-board devices, sub-systems or systems. In some embodiments, the devices 118 may include, but are not limited, to sensors (e.g., accelerometers, temperature and pressure detectors, etc.), cameras, mobile devices (e.g., smart phones), GPS or other locational devices, manned/unmanned aerial vehicles, ground vehicles, autonomous cars and/or sensor systems therein, and/or any other suitable devices. The one or more devices 118 may provide input data (e.g., streaming data) to the processing unit 113 via the communication interface 116. To communicate with the one or more devices 118, the communication interface 116 may include, for example, a wired, wireless, or mobile communications network configured to transmit data from the processing unit 113 to the one or more remote devices 118 and/or from the one or more devices 118 to the processing unit 113.

In some embodiments, the machine learning system may also include a user interface 120 configured to receive input data from a user 122 and transmit the input data to the processing unit 113. The user interface 120 may also be configured to receive output data from the processing unit 113 and present the output data to the user 122 via one or more output means. The user interface 120 may be implemented using one or more of a touchscreen or alternative type of display, audio input or output devices, a keypad, a keyboard, a mouse, or any other suitable form of input/output device.

The performance of machine learning can be further improved if contextual cues are provided as input along with base features that are directly related to an inference task. For example, consider a non-limiting example wherein an aircraft gas turbine engine includes sensors (i.e., remote devices 118) from which engine loading can be determined. If the machine learning model is given a task to discriminate between nominal or excessive engine loading, an under-performing model may be learned because contextual features such as, for example, time, weather, and/or operating mode of the engine are not considered. For example, a particular engine load during gas turbine engine cruising operations may be an excessive load while the same engine load during a take-off operation may be a nominal load.

Without distinguishing between engine contexts, training of the machine learning model may cause the model to indicate a false positive for excessive engine loading during the take-off operation. Thus, consideration of contexts may provide more useful information for an improved machine learning model thereby, for example, reducing or preventing determinations of false positives in vehicle on-board monitoring systems, as shown in the previous example. However, the number and form of possible contexts may be unknown. The machine learning system must be able to recognize both unencountered and previously encountered contexts. While the previous example relates to operation of an aircraft gas turbine engine, those of ordinary skill in the art will recognize that the present disclosure may relate to training of any number of suitable machine learning models, machine learning systems, and apparatuses using said machine learning models and systems. As another example, an operation may relate to identifying abnormal patterns indicating discrepancies and/or fraud in financial data, e.g., from the stock market, banking, or other financial institutions. A machine learning model may be given a task to discriminate between normal and abnormal patterns. In some cases, an operation may relate to identifying customer segments based on observing the data to determine customer behavior based on a recurring drift or a new drift type.

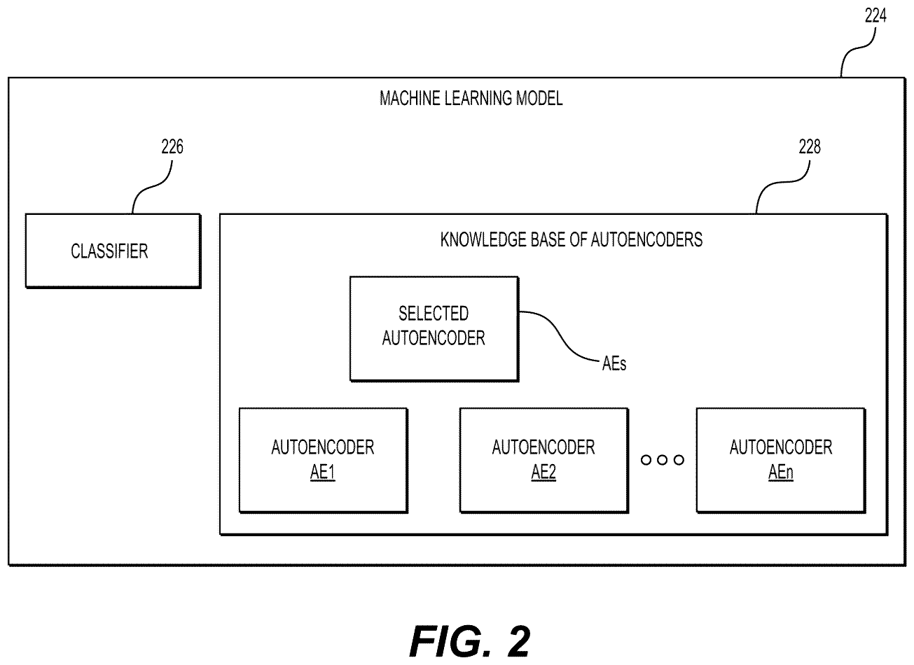

FIG. 2 is schematic diagram of a machine learning model 200, in accordance with some embodiments. The machine learning system 100 is configured to execute a machine learning model 200. The machine learning model 200 includes a classifier 226 configured to perform a data classification task. Moreover, autoencoders AE1, AE2, . . . AEn may also be implemented to perform analysis on whether drifting has occurred in the underlying data. The machine learning model further includes a knowledge base of autoencoders 228 corresponding to the previously learned contexts of the machine learning model 224. The knowledge base of autoencoders includes at least one autoencoder AE1, AE2, . . . AEn, each autoencoder of the at least one autoencoder AE1, AE2, . . . AEn corresponding to a known context. One autoencoder of the at least one autoencoder AE1, AE2, . . . AEn may be a selected autoencoder AEs corresponding to the current context of the machine learning system 100.

Each autoencoder AE1, AE2, . . . AEn serves further as a specialized dimensionality reduction model specific for that context to derive the most representative description for that context; its purpose is also to learn to disregard variations within the same context. Different contexts can have very different latent vectors/output representation as a result of multiple autoencoders AE1, AE2, . . . AEn, thus making similarity comparison easier if contexts are different.

In assessing drift, the autoencoder assigned to a specific context evaluates if current data in the same context associated with received data shows drift characteristics. Based on the drift characteristics, the autoencoder may determine if the drift is recurring or a new drift altogether.

Here, images may be sent in an input stream. The machine learning system 100 performs an extraction operation to extract features from the images. The features may be represented vectorially and defined as feature vectors. In some embodiments, input stream may include other sorts of data besides images.

An autoencoder can automatically learn useful features from the input data X and reconstruct the input data X based on the learned features. A decrease in similarity accuracy may indicate a potential change in the underlying current data in the context. This may trigger the autoencoder to compare the representation of the current context data with the average representation of the learned context computed via the knowledge base of autoencoders 228. The selected autoencoder is trained to learn a low-dimensional representation of the normal input data X by attempting to reconstruct its inputs to get \hat{X} with the following objective function:

θ=arg min [symbol] (X,g(X)). Eq. 1
where θ is the parameters of the autoencoder g (i.e., weights of the neural network), [symbol] is the loss function (typically [symbol] ₂ loss), X is the input, and \hat{X}=g=g(X) is the reconstruction of the autoencoder.

As an example, one may use cosine similarity to measure similarity between context information. The cosine similarity is defined as follows:

$$φ = \frac{\overline{x} \cdot {\overline{x}}_{{g}_{i}}}{‖ \overline{x} ‖ ‖ {\overline{x}}_{gi} ‖} \qquad Eq . 2$$

where \tilde{x} is the mean of the context data associated with an autoencoder, and \tilde{x}_{gi} is the mean of the current context data received for processing.

In some embodiments, one or more of the following is used for measuring similarity between context information include: cosine similarity, Euclidean distance, Pearson's correlation, Mahalanobis distance, Chebychev distance, Manhattan distance, Mikowski distance, or the like.

In this case, the context data may be the feature vectors extracted from each image. In some embodiments, the input parameter used for computing similarity may include latent dimension, the reconstruction error, or the like. In some embodiments, one may use other similarity measures besides cosine similarity. Note \tilde{x} and \tilde{x}_{gi} may be vectors or matrices whose entries are probabilistic mean values associated with data from the feature vectors and autoencoders used in the similarity analysis. This may include probabilistic mean values associated with output information, reconstruction errors, similarity metrics information, latent dimensional information, or the like.

A high similarity error may be observed when presented with data from a different data-generating source. The similarity errors may be modeled as a normal distribution—an anomaly (i.e., unknown context data) may be detected when the probability density of the average similarity error is below a certain predetermined threshold.

During every encounter with a context, the new data sample is evaluated against a knowledge base of autoencoders AE1, AE2, . . . AEn to derive the similarity errors where nₑ is the number of seen (and hypothesized) contexts. If all autoencoders have the similarity error ∈ is above a certain predetermined threshold, then a new context is present. Otherwise, the autoencoder with the highest similarity is determined to be associated with the context. In some embodiments, the predetermined threshold is associated with the statistical significance of the normal distribution of similarity errors.

Once the autoencoder has been selected, the machine learning system 100 determines if the current context data exhibits a recurring or new drift for the same context. This determination may depend on the relative degradation between the existing data and previous data of the context. This relative degradation is compared to a degradation threshold. If relative degradation is determined to be less than the degradation threshold, the current drift exhibited by the existing data is considered to be a recurring drift. Otherwise, the current drift is considered to be a new drift. The machine learning system 100 stores recurring drift information and new drift information for each context to assess the overall state of a context and autoencoder.

In some embodiments, the degradation threshold is static and based on dynamic context data. In some embodiments, the degradation threshold is dynamic and based on the underlying context data or other information relevant to training the autoencoders AE1, AE2, . . . AEn.

In response to determining whether a recurring drift is present, the machine learning system 100 switches to the existing context and appends the existing context data with the current context data in the selected autoencoder. Afterward, the machine learning system 100 updates the feature descriptor of the autoencoder and trains the task model using the appended existing context data and the current context data. Typically, when a recurring drift is encountered, it may signify the drift is a known type or occurred in the past, resulting in a lower relative degradation than a new one.

In response to determining whether a new drift has occurred, the machine learning system 100 proceeds with a new minibatch of data to train a new autoencoder. Afterward, the machine learning system 100 trains the autoencoder's feature descriptor and the task model using the new minibatch of data. Typically, when a new drift is encountered, it may signify the drift is not a known drift type or occurred in the past. In some embodiments, the new autoencoder is a newly initiated and added to the current bank of autoencoders AE1, AE2, . . . AEn. In some embodiments, the new autoencoder is a currently unused autoencoder from the current bank of autoencoders AE1, AE2, . . . AEn.

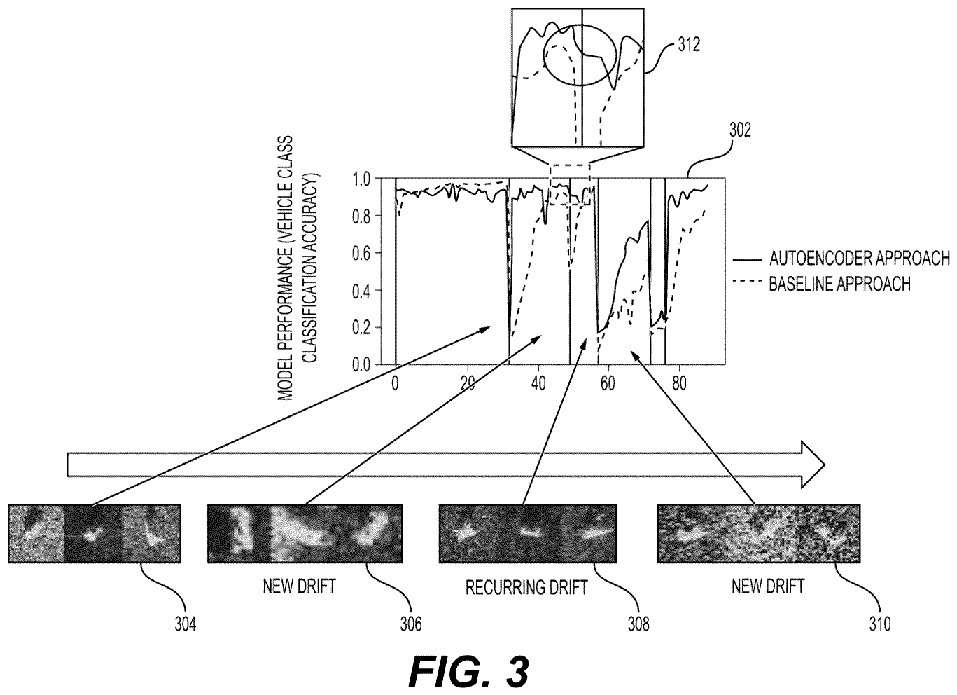

FIG. 3 is a schematic diagram illustrating the process for determining a recurring or new drift by an autoencoder, in accordance with some embodiments. Graph 302 shows an autoencoder's model performance and partial update characteristics based on data associated with contexts 304-310. The first context data that is processed is from context 304. Context 306 is processed second and exhibits a new drift not previously processed by the autoencoder. Afterward, context 308 is processed and exhibits a recurring drift due to the slight degradation shown in inlet 312. Region 314 offers a detailed representation of the degradation between contexts 306 and 308. In this case, the autoencoder trains the task model using appended data from contexts 306 and 308. Context 310 is processed and exhibits a new drift. As mentioned earlier, when a new drift is encountered, the autoencoder trains a new task model using a new minibatch of data.

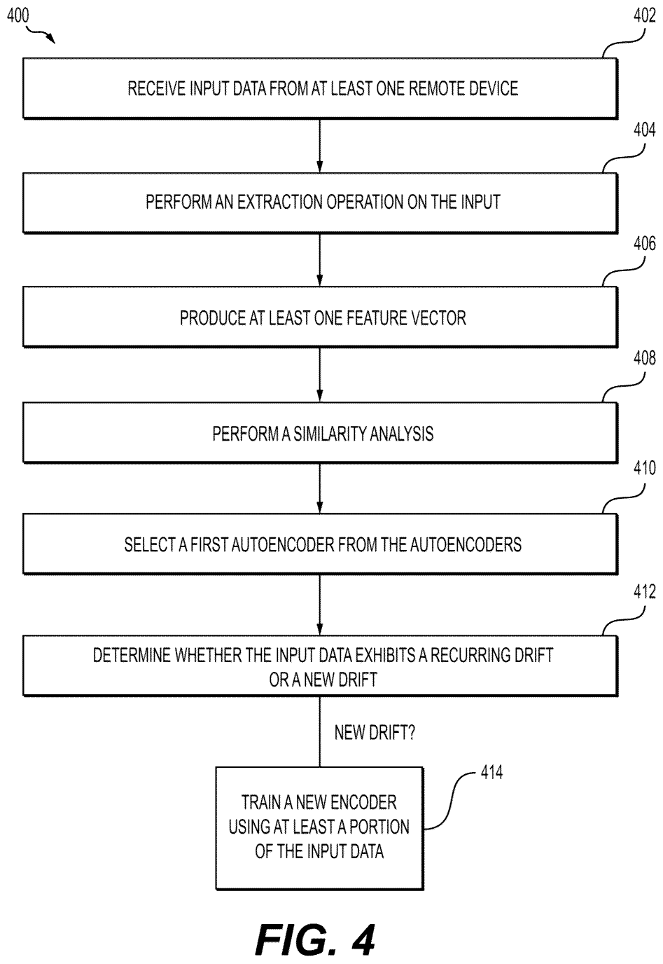

FIG. 4 is a process flowgraph of operations included in an example process 400 for a method for training a machine learning model, in accordance with some embodiments. The operations may be implemented using computer-executable instructions stored on one or more non-transitory machine-readable storage media. The instructions may be executed by one or more processing devices, such as the processor unit 113, as described in FIG. 1, to implement the operations.

Process 400 includes receiving input data (such as images) from at least one device (such as device 118)(Step 402). Process 400 includes performing an extraction operation on the input data to extract at least one feature (such as image features) (Step 404). At least one feature vector (such input data X) is produced based on the at least one feature (Step 406). Process 400 includes performing, using a similarity metric, a similarity analysis between the at least one feature vector and a plurality of other feature vectors from a plurality of autoencoders (such as autoencoders AE1 . . . AEn) (Step 408).

Process 400 includes selecting, based on the similarity analysis, a first autoencoder from the plurality of autoencoders demonstrating substantial similarity with at least one feature vector (Step 410). In this case, substantial similarity may mean the results of the similarity analysis are statistically significant. Moreover, process 300 includes determining, using current data of the first autoencoder, whether the input data exhibits a recurring drift (such as recurring drift of FIG. 3) or a new drift (such as new drift of FIG. 3) (Step 412). Upon determining the input data exhibits the new drift, process 400 includes training a new autoencoder using at least a portion of the input data (Step 414).

The disclosure describes a system and method to detect and understand drift in a continuous deployment environment. The advantages of the system and method described herein include detecting drift using autoencoders, e.g., convolutional autoencoders. Moreover, a bank of encoders is used to understand and analyze the drift from input data to determine if the drift is a recurring drift or a new drift type. All information regarding recurring drifts and new drift types is stored and used in later assessments. Depending on the type of drift observed, a system and method may implement different kinds of updating and retraining of the ML models. This requires keeping track of multiple candidate ML models in the background. Drift context is continuously updated with incoming streaming input data. An ML model may be redeployed at the user's decision or automatically deployed after revalidation.

Reference in the specification to “one implementation” or “an implementation” means that a particular feature, structure, or characteristic described in connection with the implementation is included in at least one implementation of the disclosure. The appearances of the phrase “in one implementation,” “in some implementations,” “in one instance,” “in some instances,” “in one case,” “in some cases,” “in one embodiment,” or “in some embodiments” in various places in the specification are not necessarily all referring to the same implementation or embodiment.

Finally, the above descriptions of the implementations of the present disclosure have been presented for the purposes of illustration and description. It is not intended to be exhaustive or to limit the present disclosure to the precise form disclosed. Many modifications and variations are possible in light of the above teaching. It is intended that the scope of the present disclosure be limited not by this detailed description, but rather by the claims of this application. As will be understood by those familiar with the art, the present disclosure may be embodied in other specific forms without departing from the spirit or essential characteristics thereof. Accordingly, the present disclosure is intended to be illustrative, but not limiting, of the scope of the present disclosure, which is set forth in the following claims.

What is claimed is:

1. A system for training a machine learning model, the system comprising
one or more computing device processors; and
one or more computing device memories, coupled to the one or more computing device processors, the one or more computing device memories storing instructions executed by the one or more computing device processors, wherein the instructions are configured to:
receive input data from at least one device;
perform an extraction operation on the input data to extract at least one feature;
produce at least one feature vector based on the at least one feature;
perform, using a similarity metric, a similarity analysis between the at least one feature vector and a plurality of other feature vectors from a plurality of autoencoders;
select, based on the similarity analysis, a first autoencoder from the plurality of autoencoders demonstrating substantial similarity with at least one feature vector;
determine, using current data of the first autoencoder, whether the input data exhibits a recurring drift or a new drift; and
upon determining the input data exhibits the new drift, train a new autoencoder using at least a portion of the input data.

2. The system of claim 1, wherein the instructions are further configured to, upon determining the input data exhibits the recurring drift, append the input data and the current data to retrain the first autoencoder.

3. The system of claim 1, wherein the at least one feature vector is a latent vector or an activation vector.

4. The system of claim 1, wherein while performing the similarity analysis, the instructions are configured to perform the similarity analysis on reconstruction error or latent dimensional information.

5. The system of claim 1, wherein the plurality of other feature vectors from the plurality of autoencoders comprise entries associated with probabilistic mean values of data associated with the autoencoders.

6. The system of claim 1 further comprising storing recurring drift information or new drift information of the first autoencoder.

7. The system of claim 1, wherein while determining whether the input data exhibits the recurring drift or the new drift, the instructions are configured to determine how much degradation has occurred between the input data and the current data.

8. The system of claim 7, wherein the instructions are further configured to, in response to determining the degradation, determine whether the current data exhibits the recurrent drift by verifying the degradation is below a first threshold.

9. The method of claim 8, wherein the instructions are further configured to, in response to determining the degradation, determine whether the current data exhibits the new drift by verifying the degradation is above the first threshold.

10. A method for training a machine learning model, the method comprising:
receiving input data from at least one device;
performing an extraction operation on the input data to extract at least one feature;
producing at least one feature vector based on the at least one feature;
performing, using a similarity metric, a similarity analysis between the at least one feature vector and a plurality of other feature vectors from a plurality of autoencoders;
selecting, based on the similarity analysis, a first autoencoder from the plurality of autoencoders demonstrating significant similarity with at least one feature vector,
determining, using current data of the first autoencoder, whether the input data exhibits a recurring drift or a new drift; and
upon determining the input data exhibits the new drift, training the model of a new autoencoder using at least a portion of the input data.

11. The method of claim 10, further comprising, upon determining the input data exhibits the recurring drift, appending the input data and the current data to retrain the first autoencoder.

12. The method of claim 11, wherein the at least one feature vector is a latent vector or an activation vector.

13. The method of claim 10, wherein the similarity metric includes one or more of the following: a cosine similarity function, Euclidean distance, Pearson's correlation, Mahalanobis distance, Chebyshev distance, Manhattan distance, or Mikowski distance.

14. The method of claim 10, wherein performing the similarity analysis comprises performing the similarity analysis on reconstruction error or latent dimensional information.

15. The method of claim 10, wherein the plurality of other feature vectors from the plurality of autoencoders comprise entries associated with probabilistic mean values of data associated with the autoencoders.

16. The method of claim 10 further comprising storing recurring drift information or new drift information of the first autoencoder.

17. The method of claim 10, wherein determining whether the input data exhibits the recurring drift or the new drift comprise determining how much degradation has occurred between the input data and the current data.

18. The method of claim 17, further comprising, in response to determining the degradation, determining whether the current data exhibits the recurrent drift by verifying the degradation is below a first threshold.

19. The method of claim 18, further comprising, in response to determining the degradation, determining whether the current data exhibits the new drift by verifying the degradation is above the first threshold.

20. A non-transitory computer-readable storage medium storing instructions which when executed by a computer cause the computer to perform a method for training a machine learning model, the method comprising:
receiving input data from at least one device;
performing an extraction operation on the input data to extract at least one feature;
producing at least one feature vector based on the at least one feature;
performing, using a similarity metric, a similarity analysis between the at least one feature vector and a plurality of other feature vectors from a plurality of autoencoders;
selecting, based on the similarity analysis, a first autoencoder from the plurality of autoencoders demonstrating significant similarity with at least one feature vector,
determining, using current data of the first autoencoder, whether the input data exhibits a recurring drift or a new drift; and
upon determining the input data exhibits the new drift, training a new autoencoder using at least a portion of the input data.
